(19) United States
(12) Patent Application Publication
(10) Pub. No.: US 2004/0257823 A1
(43) Pub. Date: Dec. 23, 2004

(54) Wide right-turn signals for large vehicles

(76) Inventor: Youngill Chio, Burbank, CA (US)

Correspondence Address: Eugene Oak, Ph.D.,J.D., 610 S. Van Ness Ave., Los Angeles, CA, 90005, US

(21) Appl. No.: 10/463,382

(22) Filed: Jun. 18, 2003

(51) Int. Cl. B60Q 1/00

(52) U.S. Cl. 362/487

(57) ABSTRACT

A supplemental right-turn signal having a sickle-shaped sign provided for large vehicles such as trailers, tank-lorries, large trucks, and buses which require a wide radius for making right turns is comprised of a support, a sign plate, and plurality of small light bulbs implanted on the plate along the sickle-shaped signal. The supplemental right-turn signal is attached to the rear bumper and/or rear face of the vehicle.

This invention relates to a supplemental right-turn signal for large vehicles.

### BACKGROUND OF THE INVENTION

When a large, long vehicle such as a trailer, tank-lorry, large truck, or bus makes a right turn, the driver of the vehicle must use extra caution when pulling the vehicle around a right-angled corner on a surface street, usually at busy intersections.

In the case of a semi trailer, since the tractor, which is pivotally attached to the forward end of the semi trailer, is much shorter than the semi trailer, the path of the tractor around the corner is much more of a curve than that of the semi trailer. Thus, it is necessary for the driver of the tractor to approach the intersection in the curb lane and then swing to the second lane, so that when he makes the right-hand turn, the semi trailer can follow a path substantially corresponding to a chord of the curved path of the tractor.

However, as the driver of the tractor begins to make a right turn from the second lane, a motorist approaching in the curb lane can easily assume that the curb lane will remain open. Thus, he may advance his vehicle to the intersection even though he aware that the driver of the tractor intends to make a right hand turn based on the blinking of the conventional right-turn signal on the back of the semi trailer. Most motorists are not aware that as the tractor continues to advance around the corner, the adjacent right side of the semi trailer will be pulled toward the curb lane and will ram into their vehicle causing severe damage.

1. Field of the Invention

This invention relates to a supplemental right-turn signal for large vehicles that blinks while the vehicle is turning right.

2. Description of the Prior Art

U.S. Pat. No. 2,758,401 to Wilson, U.S. Pat. No. 2,854,650 to Baker et al., U.S. Pat. No. 3,331,957 to Adams et al., and U.S. Pat. No. 4,297,675 to Rubbotom et al. illustrate signal lights for large vehicles, especially for trailers, which have a short truck and a long cargo pivotally attached to the truck. The background of their inventions is to give a message to motorists following the trailer to prevent them from getting caught between the cargo and curb because of a misjudgment based on the apparent movement of the trailer. All of the prior art have a signal light in the form of a written message of “right,” “turn,” or an arrow indicator.

U.S. Pat. Nos. 2,758,401, '2,854,650, and '3,331,957 illustrate a signal attached to the rear of a cargo chassis. U.S. Pat. No. 4,297,675 illustrates a signal attached beneath the front part of a cargo chassis. In any case, they fail to give a message of ‘what is going on now and what will happen in the next moment’ to a motorist following them, especially to those who are unfamiliar with the turning behavior of large and long vehicles.

None of the prior art effectively communicates the message of ‘wide right turn of large and long vehicle’ to such motorists as illustrated in the present invention.

### SUMMARY OF THE INVENTION

A supplemental right-turn signal having a sickle-shaped sign provided for large vehicles such as trailers, tank-lorries, large trucks, and buses which require a wide radius for making right turns is comprised of a support, a sign plate, and plurality of small light bulbs implanted on the plate along the sickle-shaped signal. The supplemental right-turn signal is attached to the rear bumper and/or rear face of the vehicle. This signal operates only when the vehicle is making a wide right turn, usually when approaching an intersection from the curb lane and swinging out to the second lane before making the right-hand turn. The small light bulbs on the signal of the current invention blink along the shape of the sickle to communite to a following motorist that the vehicle will turn along the trajectory shown on the sign. The present invention works in conjunction with the standard right-turn signal present on conventional trailers. The combination of these two right-turn signals effectively communicate to following motorists that ‘this vehicle will make a right turn following the trajectory shown in the sign’.

### BRIEF DESCRIPTION OF THE DRAWINGS

FIG. 1 is a front view of the right turn signal of the present invention.

FIG. 2 is a cross sectional side view of the right turn signal of the present invention along the line a-a′ in FIG. 1.

FIG. 3 is an enlarged cross sectional view of portion B in FIG. 2 showing the manner in which light bulbs are affixed to the panel.

FIG. 4-a is a perspective view of the socket before installation.

FIG. 4-b is a front view of the socket and the light bulb after installation.

FIG. 4-c is a rear view of the socket installed and the folding part is stretched outward after installation.

FIG. 5 is a perspective view of the right turn signal of the present invention attached to a rear bumper of a semi trailer.

FIG. 6 is another perspective view of the right turn signal of the present invention attached to a rear door of a semi trailer.

### DETAILED DESCRIPTION OF THE PREFERRED EMBODIMENT

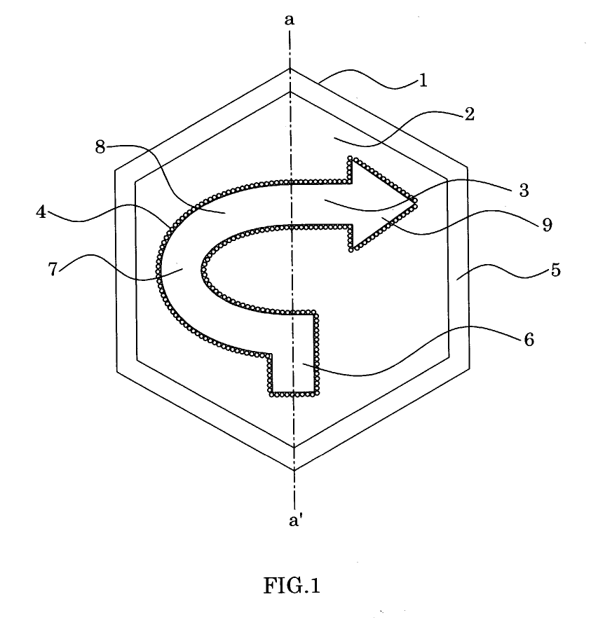

FIG. 1 is a front view of the right-turn signal (1) of the present invention. The signal (1) is comprised of a panel (2), signal plate (3), plurality of small light bulbs (4) and frame (5). The shape that the signal (1) may take includes, but is not limited to, a triangle, a square, a pentagon, a hexagon and an octagon. The panel (2) may be made of opaque plastic, metal, or composite material, but is not limited to these materials. The color of the panel (2) is yellow. The signal plate (3) may be made of opaque plastic, metal, or composite material, but is not limited to these materials. The color of the signal plate (3) may be red, green, black, or white, but is not limited to these colors. The shape of the signal plate (3) is in the form of a sickle. The lower part (6) of the signal plate (3) is a straight line and middle part (7) is a “U” shape laid aside. The end of the upper part (8) of the “U” shape laid aside is in the form of an arrow mark (9). A plurality of small light bulbs (4) are attached to the panel (2) along the outer border of the signal plate (3). The color of the bulbs (4) may be yellow, white, or red, but is not limited to these colors. The frame (5) may be made of aluminum, plastic, or stainless steel, but is not limited to these materials.

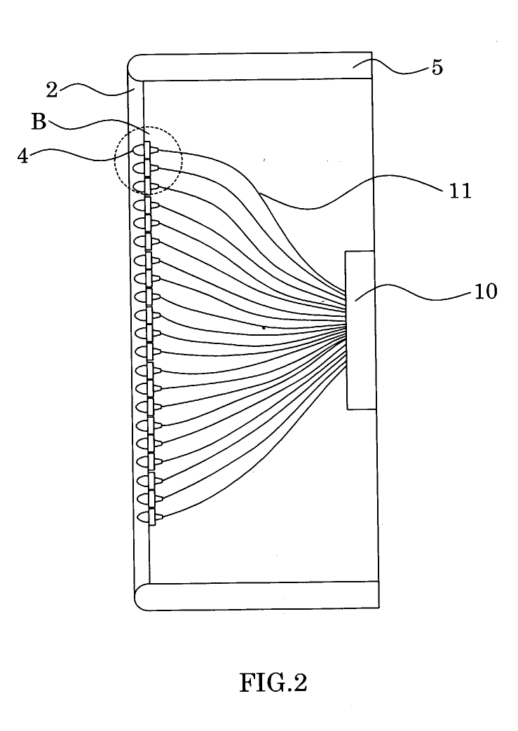

FIG. 2 is a cross sectional side view of the right turn signal of the present invention along line a-a′ of FIG. 1. A plurality of small light bulbs (4) are attached to the panel (2) along the outer border of the signal plate (3). The bulbs (4) are connected to an electric circuit board (10) by means of electric wires (11). When a driver turns on the right-turn signal the electric circuit board (10) supplies power to the light bulbs (4) in a successive pattern starting from the bottom part (6) of the signal and ending at the the arrow mark (9). The light bulbs (4) blink in order, starting from the bottom part (6), following the sickle-shaped signal (3), and ending at the arrow mark (9). This commincates to a motorist following the semi trailer that the vehicle will turn along the trajectory shown on the sign. Meanwhile, the conventional right turn signal on the trailer also blinks. The combination of these two right-turn signals communicate to a follwing motorist that ‘this vehicle will make a right turn following the trajectory shown in the sign’.

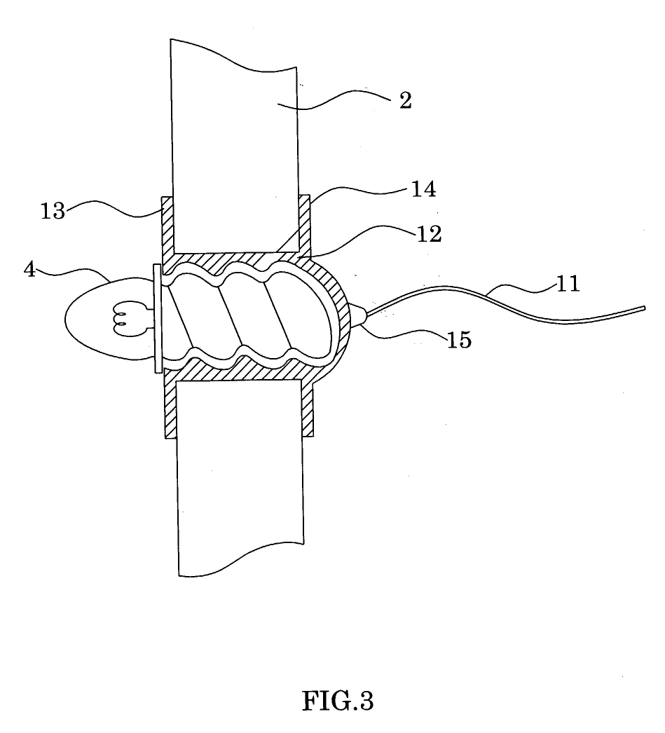

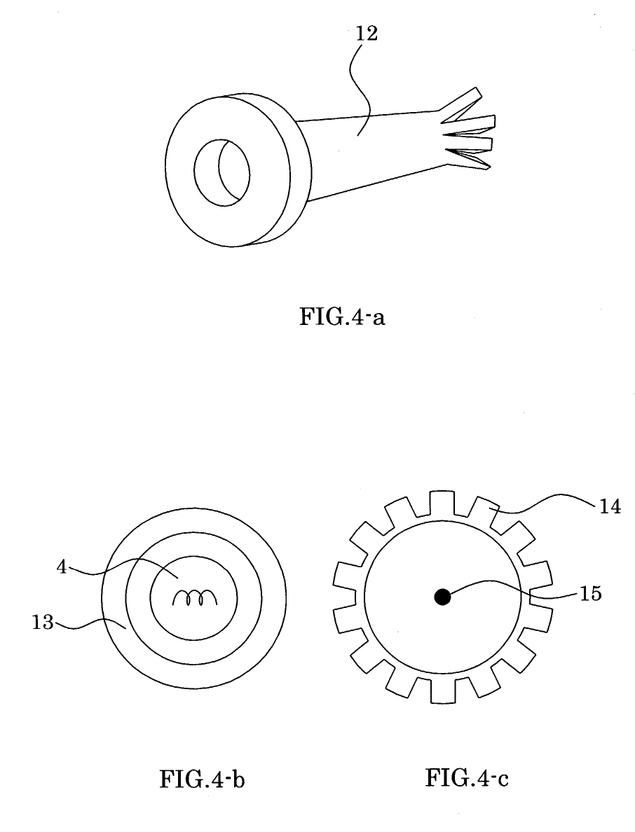

FIG. 3 is an enlarged cross sectional view of portion B in FIG. 2 showing the manner in which light bulbs (4) are affixed to the panel (2). The light bulbs (4) are inserted in threaded sockets (12), each of which is fixed to the panel (2) by the shoulder of the socket (13) and the stretched folding part (14). The socket (12) is connected to an electric wire (11) at the welding point (15). FIG. 4-a is a perspective view of the socket (12) before installation, 4-b is a front view of the socket (12) and the light bulb (4) after installation, and 4-c is the rear view of the socket (12) installed and the folding part (14) is stretched outward after installation.

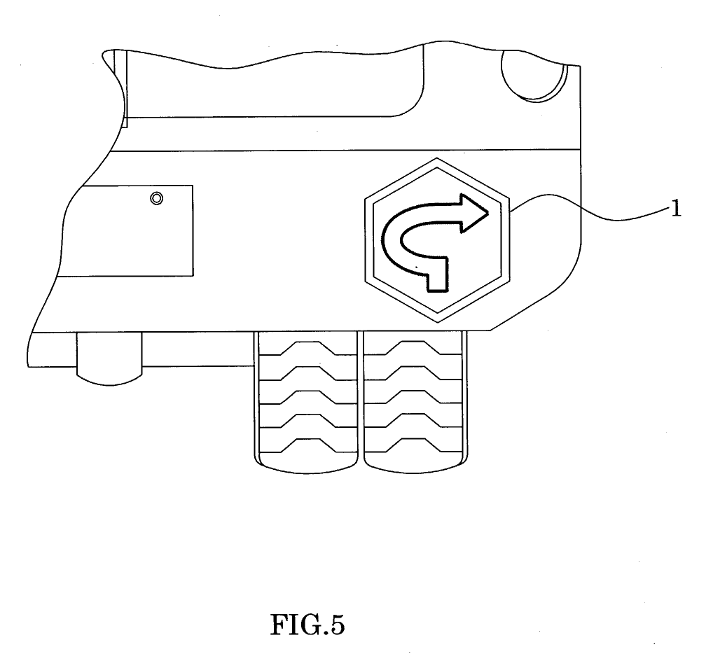

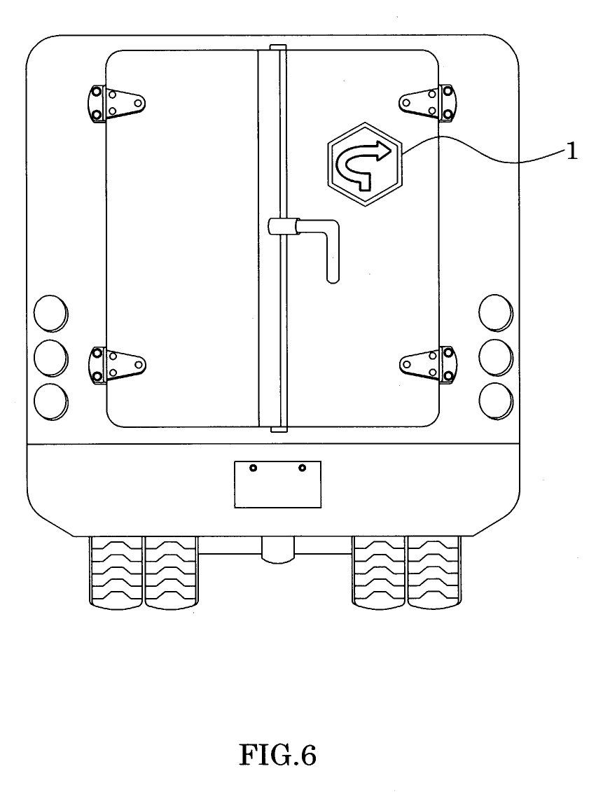

FIG. 5 and FIG. 6 show the positions at which the wide right-turn signal may be attached. These positions may be changed depending on a user's convenience.

The best mode of this invention is to make the signal with acrylate, a yellow hexagonal board (2), and a red sickle-shaped signal plate (3). A sounding alarm accompanying the blinking of the light bulbs (4) will further help a following motorist pay attention to the motion of the trailer ahead.

What is claimed is:

1. A novel supplemental wide right-turn signal unit for long and large vehicles comprising an aluminum frame, a yellow hexagonal panel, a red sickle-shaped signal plate, and a plurality of small light bulbs attached to the panel along the outer border of the signal plate, said lights blinking in a successive pattern starting from the bottom part of the signal plate, following the sickle-shape of the signal, and ending at the arrow mark, said light bulbs being powered by an electric circuit board when a driver turns on the right-turn signal of the vehicle.
